(19) United States
(12) Patent Application Publication
(10) Pub. No.: US 2006/0290299 A1
(43) Pub. Date: Dec. 28, 2006

(54) Circuit arrangement and method for operating at least one LED and at least one electric lamp

(76) Inventors: Olaf Busse, Munchen (DE); Markus Heckmann, Munchen (DE); Reinhard Lecheler, Neuburg/Donau (DE); Alfons Lechner, Hohenwart (DE); Siegfried Mayer, Moosinning (DE); Thomas Pollischansky, Stadtbergen (DE); Bernd Rudolph, Forstern (DE); Bernhard Schemmel, Wessling (DE); Kay Schmidtmann, Munchen (DE); Harald Schmitt, Munchen (DE); Thomas Siegmund, Otterfing (DE); Arwed Storm, Dachau (DE); Horst Werni, Munchen (DE)

Correspondence Address: OSRAM SYLVANIA INC, 100 ENDICOTT STREET, DANVERS, MA, 01923, US

(21) Appl. No.: 11/475,096

(22) Filed: Jun. 27, 2006

(30) Foreign Application Priority Data
Jun. 28, 2005 (DE) 10 2005 030 115.0

(51) Int. Cl. H05B 39/00

(52) U.S. Cl. 315/312

(57) ABSTRACT

A circuit arrangement for operating at least one LED and at least one electric lamp having at least one first filament and one second filament, includes first and second terminals for the corresponding filaments; and a lamp supply unit supplying power to the electric lamp; it also including an LED supply unit coupled to the second terminal for the second filament of the electric lamp and designed to supply power to the at least one LED. Also described is an operating method for the circuit arrangement operating at least one LED and at least one electric lamp as described. The circuit arrangement also includes an LED supply unit, which is coupled to the second terminal for the second filament of the electric lamp and supplies power to the at least one LED.

### TECHNICAL FIELD

The present invention relates to a circuit arrangement for operating at least one LED (light-emitting diode) and at least one electric lamp having at least one first filament and one second filament, comprising a first terminal for the first filament and a second terminal for the second filament of the electric lamp and a lamp supply unit for supplying power to the electric lamp. It also relates to a corresponding operating method for at least one LED and at least one electric lamp using such a circuit arrangement.

### PRIOR ART

The principal problem on which the present invention is based consists in both electric lamps, for example fluorescent lamps, and LEDs being operated in an illumination unit in order to achieve particular visual effects, for example in order to vary the color temperature. For this purpose, two ballasts are used in the prior art, to be precise a ballast for the light-emitting diodes and a second ballast for the fluorescent lamps. In this case, the manufacturer of such an illumination unit connects the two ballasts to the system connection of the illumination unit via corresponding lines. Disadvantages of this known solution are the complexity in terms of wiring involved for the manufacturer of such an illumination unit and the space requirement involved for the two ballasts of such an illumination unit.

### SUMMARY OF THE INVENTION

The object of the present invention consists in developing the circuit arrangement cited at the outset or the operating method cited at the outset such that a reduction in the wiring complexity and a reduction in the space requirement for the unit(s) used to drive the electric lamp(s) and the light-emitting diode(s) are possible.

In principle, the present invention is based on the knowledge that the disadvantages of the prior art can be overcome if the at least one electric lamp and the at least one LED are operated with one and the same ballast. This is because, firstly, this only requires this one ballast to be wired to the system connection. Secondly, such a ballast requires less space than the two ballasts which were required in the procedure in accordance with the prior art, in particular if specific components are used both for the operation of the at least one electric lamp and for the operation of the at least one LED.

If the current through the electric lamp is regulated, this also results in the advantage that the luminous flux of the individual LEDs is fixed within a predetermined tolerance irrespective of the number of LEDs connected. Furthermore, with the circuit arrangement according to the invention, the LEDs can also be used to establish whether the electric lamp is intact. This is because a current flow takes place to the second terminal for the second filament of the electric lamp only in the case of an intact electric lamp, i.e. the sum of the currents to the second filaments is not equal to zero, with the result that the at least one LED only illuminates when the electric lamp is not defective.

One preferred embodiment is characterized by the fact that the LED supply unit has an input and an output, the input and the output being DC-isolated from one another in terms of their potentials. The DC-isolation ensures that no direct current is transmitted from the input of the LED supply unit to the output of the LED supply unit. Owing to these measures, it is easily possible to adhere to the safety regulations for the operation of LEDs envisaged for some applications or in various countries.

The LED supply unit particularly preferably comprises a transformer, whose primary side is coupled to the second terminal. During operation, an alternating current having a constant amplitude therefore flows through the primary side of the transformer and consequently also on the secondary side of the transformer. By selecting the turns ratio, it is possible to establish the amplitude of the alternating current on the secondary side. The current through the LED determines the color and the brightness of the light output by the LED. In this case, a capacitance is preferably connected in parallel with the secondary side of the transformer. Owing to this measure, it is possible for the current through the at least one light-emitting diode to be set independently of the turns ratio of the transformer.

As an alternative to the transformer, the LED supply unit may comprise a capacitive coupling-out apparatus, which is coupled to the second terminal. In this case, the light-emitting diodes are preferably operated via two capacitors in parallel with a coupling capacitor, which is required for the operation of the electric lamp. In this case, the current through the LEDs is less than or equal to the current through the electric lamp. In this case, the capacitive coupling-out apparatus likewise ensures that no direct current is transmitted from the input to the output of the LED supply unit. In terms of good insulation properties, possible capacitive coupling-out apparatuses are, in particular, so-called X or Y capacitors.

Furthermore, a voltage limitation apparatus, in particular a zener diode is preferably connected in parallel with the at least one LED. This voltage limitation apparatus protects the at least one light-emitting diode against overload since, in the case of most light-emitting diodes, the power consumed increases with the operating voltage. In particular in the case of a plurality of series-connected LEDs, application faults of a circuit arrangement according to the invention can thus be prevented: owing to the voltage limitation apparatus being suitably dimensioned, the total number of LEDs which can be operated without an overload on the circuit arrangement and/or the total power which can be converted in the LEDs can be limited.

The LED supply unit preferably also comprises a rectifier, which is designed to provide a rectified signal at the output of the LED supply unit, i.e. at the terminal at which the at least one LED is connected to the LED supply unit. The second filament of the electric lamp is preferably the cold filament.

It is further preferred if the input of the LED supply unit is coupled between the second terminal for the electric lamp and a reference potential, in particular ground.

When connecting a plurality of LEDs to a circuit arrangement according to the invention, these LEDs are preferably connected in series.

In order to smooth the current in the LEDs, a smoothing inductor can advantageously be introduced in series in the current path of the LEDs.

Further advantageous embodiments are described in the dependent claims.

The preferred embodiments and advantages described above with reference to the circuit arrangement according to the invention apply correspondingly to the operating method according to the invention.

### BRIEF DESCRIPTION OF THE DRAWINGS

Three exemplary embodiments of a circuit arrangement according to the invention will now be described below with reference to the attached drawings, in which:

FIG. 1 shows a first exemplary embodiment of a circuit arrangement according to the invention;

FIG. 2 shows a second exemplary embodiment of a circuit arrangement according to the invention; and

FIG. 3 shows a third exemplary embodiment of a circuit arrangement according to the invention.

### PREFERRED EMBODIMENT OF THE INVENTION

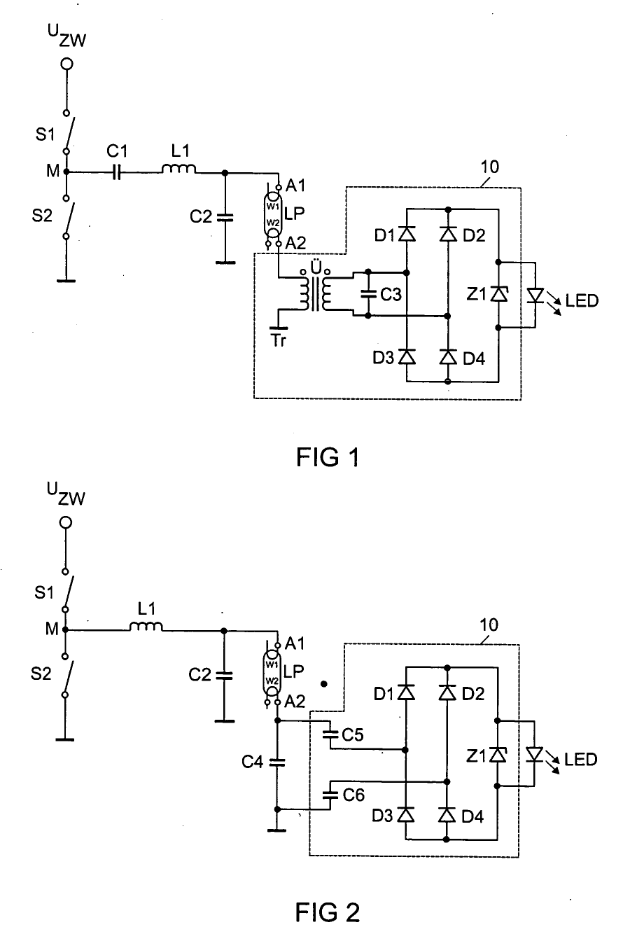

FIG. 1 shows a schematic illustration of a first exemplary embodiment of a circuit arrangement according to the invention, for reasons of clarity only the components which are relevant to the invention being illustrated. A so-called intermediate circuit voltage U_{zw} which, as is generally known, is produced from the system voltage and is generally of the order of magnitude of 400V, is applied to the series circuit comprising a first switch S1, implemented by a first bridge transistor, and a second switch S2, implemented by a second bridge transistor. In the present exemplary embodiment, a half-bridge circuit is used as the bridge circuit. However, as is obvious to a person skilled in the art, the invention can also be implemented using a full-bridge circuit or even in the case of conventional ballasts, i.e. ballasts without a bridge circuit. The switches S1 and S2 are driven, in a known manner, so as to realize an inverter. A center point M of the bridge circuit is defined between the two switches S1, S2. The bridge center point M is connected to an electric lamp LP, in particular a fluorescent lamp, via a coupling capacitor C1 and an inductance L1. A resonant capacitor C2 is arranged in parallel with the lamp LP. The circuit arrangement comprises a first terminal A1 for a first filament W1 and a second terminal A2 for a second filament W2 of the lamp LP. As can be seen from the drawing, the filament W1 is the hot filament, and the filament W2 is the cold filament of the lamp LP. An LED supply unit 10 is coupled to the second terminal A2 for the second filament W2 of the electric lamp and is designed to supply power to the at least one LED. The LED supply unit 10 comprises a transformer Tr having a transformation ratio Ü, whose primary side is coupled between the terminal A2 of the electric lamp LP and the ground potential. The secondary side of the transformer Tr is connected in parallel with a capacitor C3, which makes it possible to set the current through the at least one LED irrespective of the turns ratio Ü of the transformer Tr. The capacitor C3 is coupled to the input of a rectifier, which comprises the diodes D1 to D4, the output of the rectifier being coupled to the LED. By selecting the transformation ratio Ü of the transformer Tr and selecting the capacitance of the capacitor C3, it is possible to set the properties of the light output by the LED, in particular the light color and the brightness. In order to safeguard the LED against overload owing to excessively high voltages, in particular during starting operation of the electric lamp LP, a voltage limitation apparatus, in this case a zener diode Z1, is arranged in parallel with the LED.

FIG. 2 shows a schematic illustration of the relevant components of a second exemplary embodiment of a circuit arrangement according to the invention, in which the same reference symbols which have already been introduced with reference to FIG. 1 are used for components which correspond to those in FIG. 1. In the exemplary embodiment illustrated in FIG. 2, the LED supply unit 10 comprises a capacitive coupling-out apparatus, which is coupled to the second terminal A2 of the lamp LP. This second coupling-out apparatus comprises two capacitors C5, C6, which are operated in parallel with a coupling capacitor C4 for the lamp LP. At the times at which the potential at the terminal A2 is greater than the ground potential, a current accordingly flows via the capacitor C5, the diode D1, the LED, the diode D4 and the capacitor C6. At the times at which the potential at the terminal A2 is less than the ground potential, a current flows via the capacitor C6, the diode D2, the LED, the diode D3 and the capacitor C5.

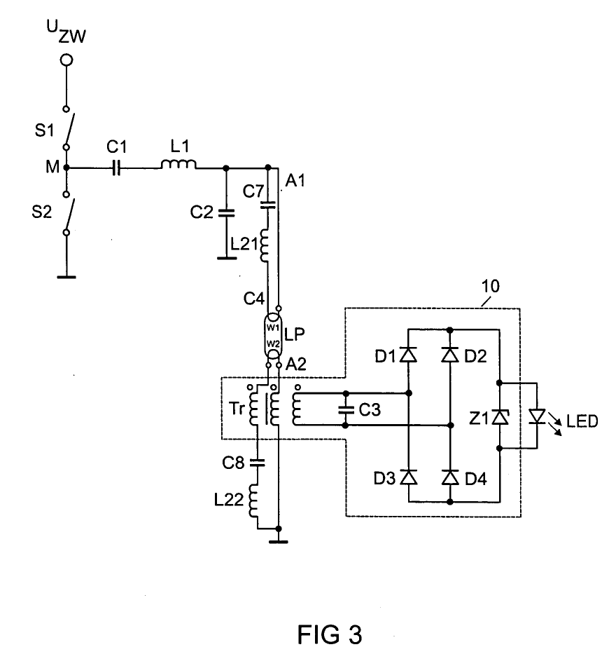

FIG. 3 shows a schematic illustration of the relevant components of a third exemplary embodiment of a circuit arrangement according to the invention, in which, in turn, the same reference symbols which have already been introduced with reference to FIG. 1 are used for components which correspond to those in FIG. 1. In the exemplary embodiment illustrated in FIG. 3, the inductance L1 in the supply line of the electric lamp LP represents the primary winding of a transformer, whose two secondary windings L21 and L22 are. arranged, together with the capacitors C7 and C8, in series with the respective terminals A1, A2 for the lamp LP for the purpose of preheating the lamp. In order to prevent the transmission of current to the LED during the preheating operation of the electric lamp LP, the primary side of the transformer Tr has a first winding and a second winding, the first winding being coupled to the first feedline of the terminal A2, and the second winding being coupled to the second feedline of the terminal A2.

1. A circuit arrangement for operating at least one LED and at least one electric lamp (LP) having at least one first filament (W1) and one second filament (W2), comprising:
a first terminal (A1) for the first filament (W1) and a second terminal (A2) for the second filament (W2) of the electric lamp (LP); and
a lamp supply unit for supplying power to the electric lamp (LP);
characterized
in that it also comprises an LED supply unit (10), which is coupled to the second terminal (A2) for the second filament (W2) of the electric lamp (LP) and is designed to supply power to the at least one LED.

2. The circuit arrangement as claimed in claim 1,
characterized
in that the LED supply unit (10) has an input and an output, the input and the output being DC-isolated from one another in terms of their potentials.

3. The circuit arrangement as claimed in claim 1,
characterized
in that the LED supply unit (10) comprises a transformer, whose primary side is coupled to the second terminal (A2).

4. The circuit arrangement as claimed in claim 3,
characterized
in that the secondary side of the transformer (Tr) is connected in parallel with a capacitance.

5. The circuit arrangement as claimed in claim 1,
characterized
in that the LED supply unit (10) comprises a capacitive coupling-out apparatus, which is coupled to the second terminal (A2).

6. The circuit arrangement as claimed in claim 1,
characterized
in that a voltage limitation apparatus, in particular a zener diode (Z1), is connected in parallel with the at least one LED.

7. The circuit arrangement as claimed in claim 1,
characterized
in that the LED supply unit (10) comprises a rectifier, which is designed to provide a rectified signal at the output of the LED supply unit (10).

8. The circuit arrangement as claimed in claim 1,
characterized
in that the second filament (W2) of the electric lamp (LP) is the cold filament.

9. The circuit arrangement as claimed in claim 1,
characterized
in that the input of the LED supply unit (10) is coupled between the second terminal (A2) for the electric lamp (LP) and a reference potential, in particular ground.

10. The circuit arrangement as claimed in claim 1,
characterized
in that a smoothing inductor is connected in series with the at least one LED.

11. An operating method for at least one LED and at least one electric lamp (LP) having at least one first filament (W1) and one second filament (W2) using a circuit arrangement having a first terminal (A1) for the first filament (W1) and a second terminal (A2) for the second filament (W2) of the electric lamp (LP) and a lamp supply unit (10) for supplying power to the electric lamp (LP);
characterized
in that the circuit arrangement also comprises an LED supply unit (10), which is coupled to the second terminal (A2) for the second filament (W2) of the electric lamp (LP) and supplies power to the at least one LED.

12. The circuit arrangement as claimed in claim 2,
characterized
in that the LED supply unit (10) comprises a transformer, whose primary side is coupled to the second terminal (A2).

13. The circuit arrangement as claimed in claim 2,
characterized
in that the LED supply unit (10) comprises a capacitive coupling-out apparatus, which is coupled to the second terminal (A2).
